(19) United States
(12) Patent Application Publication
(10) Pub. No.: US 2020/0226893 A1
(43) Pub. Date: Jul. 16, 2020

(54) ELECTRONIC EDGE COMPUTING DEVICE

(71) Applicant: Toshiba Client Solutions CO., LTD., Tokyo (JP)

(72) Inventors: Masanori Nakano, Koganei Tokyo (JP); Sy Pan, Taipei (TW); Julia Tsai, Taipei (TW)

(21) Appl. No.: 16/834,512

(22) Filed: Mar. 30, 2020

Related U.S. Application Data
(63) Continuation of application No. 16/020,821, filed on Jun. 27, 2018.

(30) Foreign Application Priority Data
Dec. 28, 2017 (JP) 2017-253081

(51) Int. Cl. G08B 5/38; G06F 3/01; H05B 45/20

(52) U.S. Cl. CPC G08B 5/38; H05B 45/20; G06F 3/011

(57) ABSTRACT

According to one embodiment, an electronic edge computing device is without a display and without a hardware input keyboard. The electronic edge computing device includes a light source and a controller. The light source emits light of at least two colors. A light emission mode of the light source comprises an on mode, a blink mode, and an off mode. The controller controls a color of the light emitted from the light source and the light emission mode of the light source based at least in part on a state of the electronic edge computing device.

### CROSS-REFERENCE TO RELATED APPLICATIONS

This application is a continuation of U.S. application Ser. No. 16/020,821, filed on Jun. 27, 2018, which is based upon and claims the benefit of priority from Japanese Patent Application No. 2017-253081, filed Dec. 28, 2017, the entire contents of which are incorporated herein by reference.

### FIELD

Embodiments described herein relate generally to an electronic edge computing device.

### BACKGROUND

Recently, an IoT (Internet of Things) of which many things of electronic products are connected through the Internet has been introduced in many scenes. A technique called “edge computing” which is relating to the IoT is required as a tool for network communication and information sharing in offices, factories, and in other various situations. In order to realize the edge computing, development of a practical mobile edge computing device having high degrees of versatility and high processing capacity, and able to be used by a user (or worker) on site, is needed separately from a data center (or cloud). Thereby, it is expected that promotion of the operational efficiency and productivity improvement at a workplace and the like, or load dispersion of data and improvement of a network environment will be achieved.

When the mobile edge computing device is provided with a display or a hardware input keyboard for inputting characters or numerals, the worker has difficulty being dedicated to work. Therefore, there is proposed a mobile edge computing device which is provided with no display device or hardware input keyboard. If eyeglass-type wearable device is connected to such a mobile edge computing device, a display unit of the eyeglass-type wearable device may be used as a display device of the mobile edge computing device, and the user may check the display while performing the work.

Since such an electronic edge computing device provided no display device, it is difficult for a user of the electronic edge computing device to determine whether the electronic edge computing device operates normally or is malfunctioning.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of a remote support system including an electronic edge computing device according to an embodiment.

FIG. 2 is a block diagram showing an exemplary structure of an operator terminal 12 in FIG. 1.

FIG. 3 is a view showing an example of an external appearance of a wearable device 23 to be connected to a mobile PC 16 in FIG. 1.

FIG. 4 is a view showing an example of an external appearance of a wearable device main body 24.

FIG. 5A is a view showing an example of connection between the mobile PC 16 and the wearable device main body 24.

FIG. 5B is a view showing an example of connection between a plug 146A of a USB type-C cable 146 and a receptacle 132A in the wearable device main body 24.

FIG. 5C is a view showing another example of connection between the plug 146A of the USB type-C cable 146 and a receptacle 132A in the wearable device main body 24.

FIG. 6 is a block diagram showing an exemplary structure of the wearable device main body 24.

FIG. 7 is a view showing an example of an external appearance of the mobile PC 16.

FIG. 8 is a block diagram showing an exemplary structure of the mobile PC 16.

FIG. 9A shows an example of a normal mode of five buttons 202.

FIG. 9B shows an example of a numeric key mode of the five buttons 202.

FIG. 10 shows an example of switching between the normal mode and the numeric key mode.

FIG. 11 shows an example of a lighting state of a power LED 213 and a DC IN/battery LED 214 of the mobile PC 15.

FIG. 12 shows an example of functions executed when the five buttons of the mobile PC 16 are operated and an example of a lighting state of the power LED 213.

FIG. 13 shows an example of a lighting state of the DC IN/battery LED 214 in a battery check time of the mobile PC 16.

FIGS. 14A, 14B, and 14C show modified examples of the arrangement of the power LED 213 and the DC IN/battery 214 in the mobile PC 16.

### DETAILED DESCRIPTION

Various embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

A remote support system is described as an embodiment of an electronic edge computing device. However, an electronic edge computing device according to an embodiment can be applied to other systems.

In general, according to one embodiment, an electronic edge computing device is without a display and without a hardware input keyboard. The electronic edge computing device includes a light source and a controller. The light source emits light of at least two colors. A light emission mode of the light source comprises an on mode, a blink mode, and an off mode. The controller controls a color of the light emitted from the light source and the light emission mode of the light source based at least in part on a state of the electronic edge computing device.

[Remote Support System]

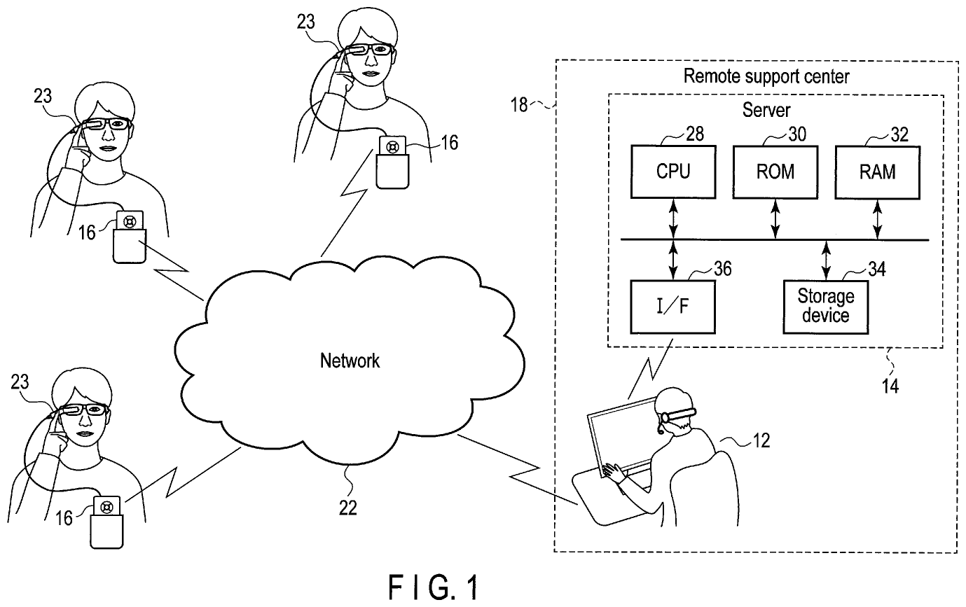

FIG. 1 is a block diagram showing an example of a remote support system that realizes edge computing. The remote support system is used by an operator at a remote site to support a user, for example, a user at a workplace. Examples of work at the workplace include a complicated maintenance service, picking operation in a distribution warehouse, monitoring of a workplace, disaster relief/medical support, and the like. The user side of the workplace is also called a front end, and the operator side at the remote site is also called a back end or a rear end. In the remote support system, a mobile personal computer (PC) (also called a mobile edge computing device in some cases) 16 carried by the user and remote support center (data center) 18 located at a position distant from the user are connected to each other through a network 22, such as the Internet, so that communication can be carried out between them. The mobile PC 16 and the remote support center 18 may be connected to the network 22 through wired LAN cables or may be connected to the network 22 through a wireless LAN, Bluetooth (registered trade mark), and the like.

A wearable device 23 is connected to the mobile PC 16. Although FIG. 1 shows an example in which the wearable device 23 is connected to the mobile PC through a cable, the wearable device 23 may also be connected to the mobile PC 16 through a wireless LAN, Bluetooth or the like. The wearable device 23 is provided with a camera and a display device. An image shot by the camera may be transmitted to the mobile PC 16, and the image transmitted from the mobile PC 16 may be displayed on the display device.

As shown in FIG. 1, it is also possible for a plurality of users to communicate with each other through the network 22. In this case, communication may also be carried out through the remote support center 18, and communication may also be carried out only between the users without being carried out through the operator of the remote support center 18.

The remote support center 18 is provided with an operator terminal 12 and a server 14. The remote support center 18 makes a voice call or information exchange between the mobile PC 16 (wearable device 23) and the operator terminal 12. It is possible to carry out video distribution of a real-time image shot by the wearable device 23 (connected to the mobile PC 16) to the operator terminal 12, and it is also possible to carry out mutual transmission/reception of an image between the mobile PC 16 and the operator terminal 12. Further, it is also possible to transmit a text message from the operator terminal 12 to the mobile PC 16. For example, in the picking operation at the distribution warehouse, a place of a picking item is displayed on the wearable device 23, whereby hands-free picking can be realized.

The remote support typically includes, for example, the following functions:

(1) A voice call function of carrying out an interactive voice call between the mobile PC 16 and the operator terminal 12.

(2) A live image distribution function of carrying out video distribution of a real-time image shot by the wearable device 23 to the operator terminal 12 during a voice call.

(3) A function of carrying out transmission/reception of a still image between the mobile PC 16 and the operator terminal 12 during a voice call (The mobile PC 16 transmits a shot still image or a captured image being video-distributed to the operator terminal 12. The operator terminal 12 edits the received image by writing characters or pictures, and transmits the edited image to the mobile PC 16. The still image received by the mobile PC 16 is stored in a folder in the mobile PC 16, and can be browsed).

(4) A screen sharing function of displaying the entire desk-top screen of the operator terminal 12 or a window of an arbitrary application program on the wearable device 23 during a voice call.

(5) A text message transmitting function of transmitting a text message from the operator terminal 12 to the mobile PC 16.

The server 14 carries out processing for remote support in place of or in cooperation with the operator terminal 12, and is provided with a processor (CPU) 28, ROM 30, RAM 32, and a storage device 34 such as a hard disk drive (HDD) or solid-state drive (SSD), and interface 36. The operator terminal 12 may be made to have all the functions of the server 14, and the server 14 may be omitted.

[Operator Terminal 12]

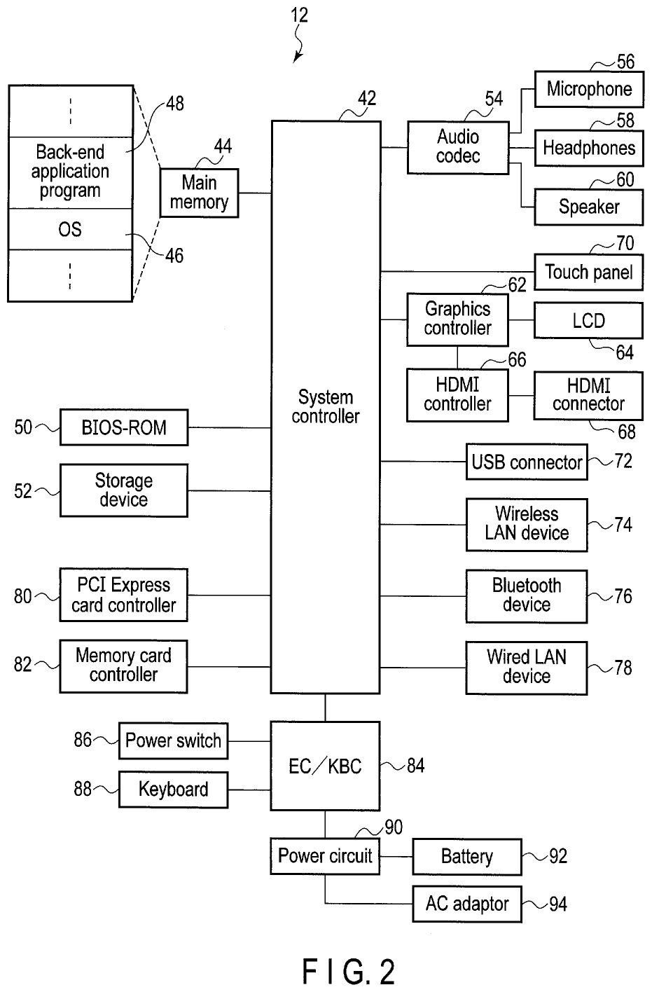

FIG. 2 is a block diagram showing an exemplary structure of the operator terminal 12. The operator terminal 12 is constituted of a desktop PC, notebook PC or the like.

The operator issues an instruction to the user having the mobile PC 16 with a conversation or an image while confirming the situation of the workplace on the basis of a real-time image by using the operator terminal 12. The operator can write pictures or characters to the image file received from the mobile PC 16 by using the operator terminal 12 to edit the image file, transmit the edited image file to the mobile PC 16, and store the edited image file into the operator terminal 12.

The operator terminal 12 is provided with a system controller 42 including a processor. A main memory 44, a BIOS-ROM 50, a storage device 52 such as an HDD or an SSD, an audio codec 54, a graphics controller 62, a touch panel 70, a USB (registered trade mark) connector 72, a wireless LAN device 74, a Bluetooth device 76, a wired LAN device 78, a PCI Express (registered trade mark) card controller 80, a memory card controller 82, an embedded controller/keyboard controller (EC/KBC) 84, and the like are connected to the system controller 42.

The system controller 42 executes various programs to be loaded from the storage device 52 into the main memory 44. These programs include an operating system (OS) 46, and back-end application program 48 for remote support. The system controller 42 also executes the Basic Input/Output System (BIOS) stored in the BIOS-ROM 50 which is a nonvolatile memory. The BIOS is a system program for hardware control.

The audio codec 54 converts a digital audio signal which is an object (to be reproduced) into an analog audio signal, and supplies the converted analog audio signal to headphones 58 or a speaker 60. Further, the audio codec 54 converts an analog audio signal input thereto from a microphone 56 into a digital signal. The microphone 56 and headphones 58 may be provided singly, and may also be provided in an integrated manner as an intercom.

The graphics controller 62 controls a liquid crystal display (LCD) 64 to be used as a display monitor of the operator terminal 12. The touch panel 70 is overlaid on the screen of the LCD 64, and allows a handwriting input operation to be carried out on the screen of the LCD 64 by means of a touch-pen or the like. An HDMI (registered trade mark) controller 66 is also connected to the graphics controller 62. The HDMI controller 66 is connected to an HDMI connector 68 for connection to an external display device (not shown).

The wireless LAN device 74 executes wireless LAN communication of the IEEE802.11 standard for the purpose of connection to the network 22. The Bluetooth device 76 executes wireless communication of the Bluetooth standard for the purpose of connection to an external device (not shown). The wired-LAN device 78 executes wired LAN communication of the IEEE802.3 standard for the purpose of connection to the network 22. As described above, the connection between the operator terminal 12 and the network 22 may be made by wireless communication or may be made by wired communication.

The PCI Express card controller 80 carries out communication of the PCI Express standard between the operator terminal 12 and an external device (not shown). The memory card controller 82 writes data into a storage medium (not shown), for example, a memory card such as an SD (Secure Digital) card (registered trade mark), and reads data from the memory card.

The EC/KBC 84 is a power management controller, and is realized as a one-chip microcomputer incorporating therein also a keyboard controller that controls a hardware input keyboard 88. The EC/KBC 84 has a function of powering on or powering off the operator terminal 12 according to an operation of a power switch 86. Control of the power-on and power-off is executed by cooperation between the EC/KBC 84 and a power circuit 90. Even while the operator terminal 12 is in the power-off state, the EC/KBC 84 operates by power from a battery 92 or an AC adaptor 94 (to be connected as an external electric power supply). The power circuit 90 uses the power from the battery 92 or from the AC adaptor 94 to generate the power to be supplied to each component.

[Wearable Device 23]

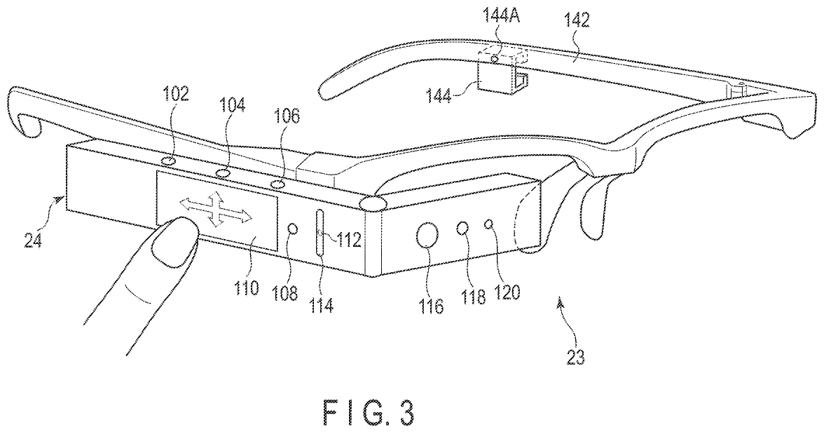

FIG. 3 shows an example of an external appearance of the wearable device 23 to be connected to the mobile PC 16. The wearable device 23 is provided with an eyeglass frame 142 and a wearable device main body 24. The eyeglass frame 142 may have a shape obtained by removing lenses from general eyeglasses and is worn on the face of the user. The eyeglass frame 142 may have a structure to which eyeglasses can be attached. When the user habitually uses eyeglasses at all times, lenses of degrees identical to the habitually used eyeglasses may be attached to the eyeglass frame 142.

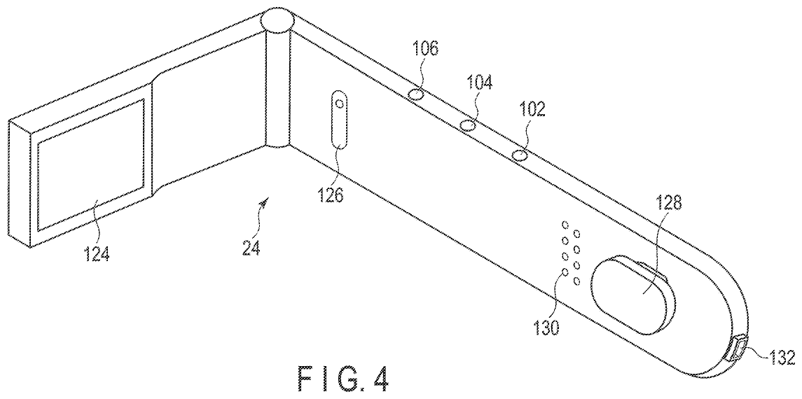

The eyeglass frame 142 is provided with mounting brackets 144 on both the right and left temples thereof. The wearable device main body 24 is attached to and detached from one of the mounting brackets 144 on the right temple or the left temple. In FIG. 3, the mounting bracket 144 on the temple at the right side of the user is hidden behind the wearable device main body 24, and hence is not shown. As described above, the wearable device main body 24 is provided with a display device 124 (shown in FIG. 4). The display device 124 is viewed by one eye. Therefore, the mounting brackets 144 are provided on both the right temple and the left temple so that the wearable device main body 24 can be attached to the mounting bracket on the dominant eye side. The wearable device main body 24 need not be detachably attached to the eyeglass frame 142 by means of the mounting bracket 144. The wearable device for the right eye only may be prepared in which the wearable device main body 24 is fixed to the eyeglass frame 142 on the right frame. The wearable device for the left eye only may be prepared in which the wearable device main body 24 is fixed to the eyeglass frame 142 on the left frame. Furthermore, the wearable device main body 24 may not be attached to the eyeglass frame 142, but may be attached to the head of the user by using a helmet or a goggle.

An engaging piece 128 (shown in FIG. 4) of the wearable device main body 24 is forced between upper and lower frames of the mounting bracket 144, whereby the wearable device main body 24 is attached to the eyeglass frame 142. When the wearable device main body 24 is to be detached from the eyeglass frame 142, the wearable device main body 24 is plucked out of the mounting bracket 144.

In a state where the wearable device main body 24 is attached to the mounting bracket 144, the engaging piece 128 is somewhat movable backward and forward in the mounting bracket 144. Accordingly, the wearable device main body 24 is adjustable in the front-back direction so that the user's eye can be brought to a focus on the display device 124. Furthermore, the mounting bracket 144 is rotatable around an axis 144A perpendicular to the temple. After the wearable device main body 24 is attached to the eyeglass frame 142, the wearable device main body 24 is adjustable in the upward or the downward direction so that the display device 124 can be positioned on the user's line of sight. Moreover, the rotational angle of the mounting bracket 144 is about 90 degrees and, by largely rotating the mounting bracket 144 in the upward direction, the wearable device main body 24 can be flipped up from the eyeglass frame 142. Thereby, even when it is difficult to watch the real thing because the field of view is obstructed by the wearable device main body 24 or even when the wearable device main body 24 interferes with surrounding objects in a small space, it is possible to temporarily divert/restore the wearable device main body 24 from/to the field of view of the user without detaching/reattaching the entire wearable device 23 from/to the face of the user.

[Wearable Device Main Body 24]

The wearable device main body 24 is constituted of a side part to be along the temple of the eyeglass frame 142, and a front part to be positioned on the line of sight of one eyeball of the user. The angle which the front part forms with the side part is adjustable.

As shown in FIG. 3, on the outside surface of the front part, a camera 116, a light 118, and a camera LED 120 are provided. The light 118 is an auxiliary lighting fixture emitting light at the time of shooting a dark object. The camera LED 120 is turned on at the time of shooting a photograph or a video to thereby cause the objective person to be photographed to recognize that he or she is to be photographed.

On the top surface of the side part of the wearable device main body 24 attached to the right side temple, first, second, and third buttons 102, 104, and 106 are provided. When the dominant eye of the user is the left eye, the wearable device main body 24 is attached to the left side temple. The top and the bottom of the wearable device main body 24 are reversed according to whether the wearable main body 24 is attached to the right side temple or the left side temple. Therefore, the first, second, and third buttons 102, 104, and 106 may be provided on both the top surface and the undersurface of the side part.

On the outside surface of the side part, a touch pad 110, a fourth button 108, a microphone 112, and an illuminance sensor 114 are provided. The touch pad 110 and the fourth button 108 can be operated by a forefinger. When the wearable device main body 24 is attached to the right side temple, the buttons 102, 104, and 106 are arranged such that the buttons 102, 104, and 106 can be operated by a forefinger, a middle finger, and a third finger, respectively. The touch pad 110 detects the movement of finger in up and down directions or back and forth directions on the surface on the touch pad 110 as indicated by arrows. The movement to be detected includes flicking of a finger for grazing the surface quickly in addition to dragging of a finger for moving the finger with the finger kept in contact with the surface. Upon detection of up-and-down or back-and-forth movement of the user's finger, the touch pad 110 inputs a command. In this description, the command implies an executive instruction to execute specific processing to be issued to the wearable device main body 24. Operation procedures for the first to fourth buttons 102, 104, 106, and 108, and the touch pad 110 are determined in advance by the application program.

For example,

when the third button 106 is pressed once, item selection/item execution is carried out,

when the third button 106 is pressed for a long time, a list of activated application programs is displayed,

when the second button 104 is pressed once, the screen returns to the home screen,

when the second button 104 is pressed for a long time, a menu of quick settings is displayed, and

when the first button 102 is pressed once, cancellation (operation identical to the operation of the Esc key of the hardware input keyboard) of an operation is executed.

Regarding the operation of the touch pad 110, for example,

when the touch pad 110 is dragged up or down, the cursor is moved up or down,

when the touch pad 110 is flicked forward (to the front of the head), the left icon is selected (continuously scrolled),

when the touch pad 110 is flicked backward (to the back of the head), the right icon is selected (continuously scrolled),

when the touch pad 110 is dragged forward, the left icon is selected (items are scrolled one by one), and

when the touch pad 110 is dragged backward, the right icon is selected (items are scrolled one by one).

The first button 102 is arranged at such a position as to be operated by a forefinger, the second button 104 at a position by a middle finger, the third button 106 at a position by a third finger, and the fourth button 108 at a position by a little finger. The reason why the fourth button 108 is provided not on the top surface of the side part, but on the outside surface of the side part in FIG. 3 is that there is no space for the fourth button 108 on the top surface. The fourth button 108 may be provided on the top surface of the side part in the same manner as the first to third buttons 102, 104, and 106 if the top surface has an enough space. The illuminance sensor 114 detects the illuminance of the surrounding area in order to automatically adjust the brightness of the display device 124.

FIG. 4 shows an example of an external appearance of the back side of the wearable device main body 24. On the inner side of the front part, the display device 124 is provided. On the inner side of the side part, a microphone 126, a speaker 130, and the engaging piece 128 are provided. The microphone 126 is provided at a front position of the side part, and the speaker 130 and the engaging piece 128 are provided at a rear position of the side part. Headphones may be used in place of the speaker 130. In this case, the microphone 126 and the headphones may also be provided in an integrated manner as an intercom in the same manner as the operator terminal 12.

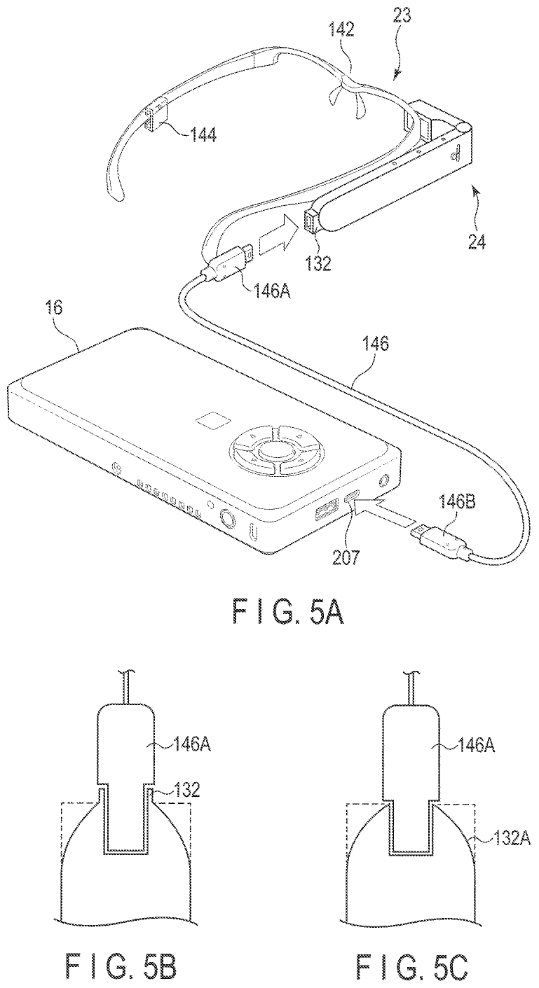

FIGS. 5A, 5B, and 5C show an example of connection between the mobile PC 16 and the wearable device main body 24. At a rear position of the side part, a receptacle 132 into which a plug 146A at one end of a USB type-C cable 146 conforming to the USB type-C (registered trade mark) standard is to be inserted is provided. The receptacle 132 and the plug 146A may be generally called a connector. A plug 146B at the other end of the USB type-C cable 146 is inserted into a receptacle 207 conforming to the USB type-C standard provided on an upper end face of the mobile PC 16. The receptacle 207 and the plug 146B may be generally called a connector. As described above, the wearable device main body 24 is connected to the mobile PC 16 through the USB type-C cable 146, and an image signal and the USB signal are transmitted from/to the wearable device main body 24 to/from the mobile PC 16 through the USB type-C cable 146. The wearable device main body 24 may also be connected to the mobile PC 16 by means of wireless communication such as a wireless LAN, Bluetooth, and the like.

In the embodiment, the wearable device main body 24 is not provided with a battery or a DC terminal serving as a drive power supply, and the drive power is supplied from the mobile PC 16 to the wearable device main body 24 through the USB type-C cable 146. However, the wearable device main body 24 may also be provided with a drive power supply.

The rear position of the side part of the wearable device main body 24 at which the receptacle 132 is formed is a curved surface. As shown in FIGS. 5B and 5C, a concave portion functioning as the receptacle 132 is formed in the curved surface. FIG. 5B shows the receptacle 132 according to the embodiment. FIG. 5C shows a receptacle 132A according to a comparative example. An intensity of the receptacle 132A shown in FIG. 5C in a direction perpendicular to an axis of the plug 146A is weaker than an intensity of a receptacle if the rear position of the side part of the wearable device main body 24 is a flat surface as shown in a broken line. Therefore, if a head of the user moves, the plug 146A becomes unstable in the receptacle 132A and may be pulled out from the receptacle 132A. Further, the receptacle 132A may be damaged or broken due to the unstable receptacle 132A.

According to the embodiment, the receptacle 132 has a projection at an edge of the concave portion in the curved surface, as shown in FIG. 5B. The projection reinforces the edge of the receptacle 132. Therefore, the probability of pulling out the plug 146A or damaging the receptacle 132A can be lowered.

When connection of the plug 146A and the receptacle 132 is too firm, the user may be dangerous if the cable 146 is got caught on other things. For example, when working at a narrow dangerous place and a head is pulled by the cable got caught on the other things, the head may be approached to a dangerous thing. When connection of the plug 146A and the receptacle 132 is too loose, the plug 146A may be pulled out from the receptacle 132A even if a weak force is applied to the plug 146A. Therefore, the strength of connection of the plug 146A and the receptacle 132 is suitably adjusted such that the plug 146A can be pulled out from the receptacle 132A when a moderate force is applied to the plug 146A. The connection strength can be adjusted by adjusting a stroke length of the plug 146A and the receptacle 132A, or a force of spring of the receptacle 132A pressing the plug 146A.

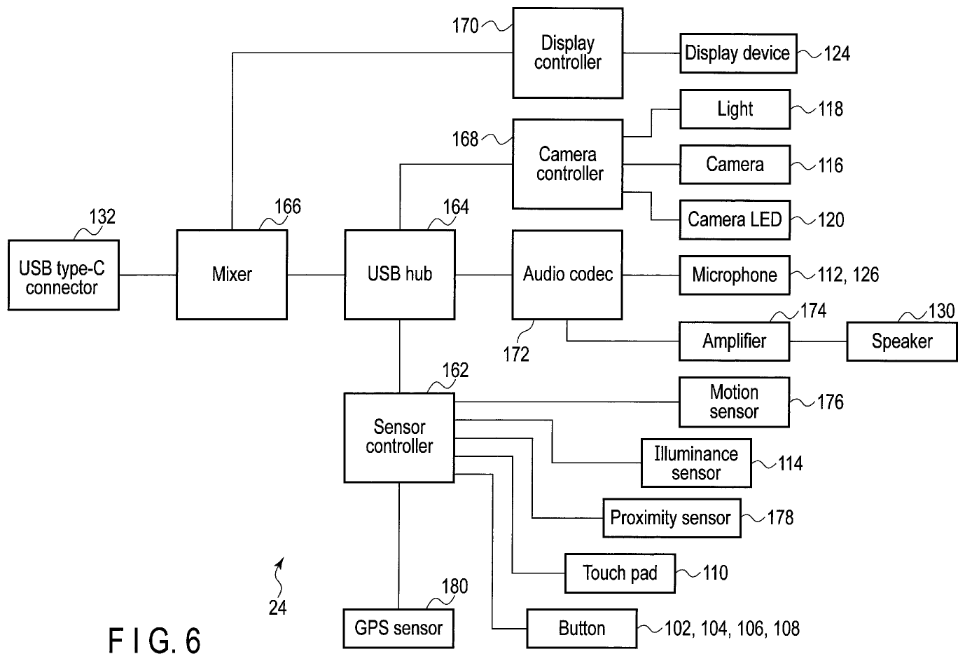

FIG. 6 is a block diagram showing an exemplary structure of the wearable device main body 24. The USB type-C connector 132 is connected to a mixer 166. A display controller 170 and a USB hub 164 are respectively connected to a first terminal and a second terminal of the mixer 166. The display device 124 is connected to the display controller 170. A camera controller 168, an audio codec 172, and a sensor controller 162 are connected to the USB hub 164. The camera 116, the light 118, and the camera LED 120 are connected to the camera controller 168. Audio signals from the microphones 112 and 126 are input to the audio codec 172, and an audio signal from the audio codec 172 is input to the speaker 130 through an amplifier 174.

A motion sensor (for example, an acceleration sensor, a geomagnetism sensor, a gravitation sensor, a gyroscopic sensor, etc.) 176, the illuminance sensor 114, a proximity sensor 178, the touch pad 110, the first to fourth buttons 102, 104, 106, and 108, and a GPS sensor 180 are connected to the sensor controller 162. The sensor controller 162 processes detection signals from the motion sensor 176, the illuminance sensor 114, the proximity sensor 178, the touch pad 110, the first to fourth buttons 102, 104, 106 and 108, and the GPS sensor 180, and supplies a command to the mobile PC 16. Although not shown in FIG. 4, the motion sensor 176 and the proximity sensor 178 are arranged inside the wearable device main body 24. The motion sensor 176 detects a motion, a direction, a posture and the like of the wearable device main body 24. The proximity sensor 178 detects attachment of the wearable device 23 on the basis of approach of a face, a finger and the like of the user thereto.

[Mobile PC 16]

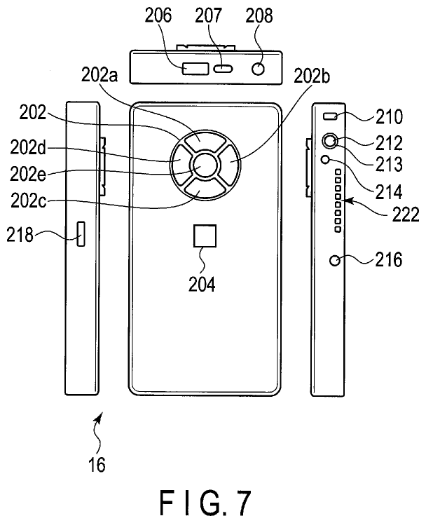

FIG. 7 shows an example of an external appearance of the mobile PC (mobile edge computing device) 16. The mobile PC 16 is a small-sized PC that can be held by one hand, and has a small size and light weight, i.e., a width thereof is about 10 cm or less, a height thereof is about 18 cm or less, a thickness thereof is about 2 cm or less, and a weight thereof is about 300 g or less. Accordingly, the mobile PC 16 can be held in a pocket of the work clothing of the user, a holster to be attached to a belt, or a shoulder case, and is wearable. Although the mobile PC 16 incorporates therein semiconductor chips such as a CPU, a semiconductor memory and the like, and storage devices such as an SSD and the like, the mobile PC 16 is not provided with a display device and a hardware input keyboard for inputting characters or numerals.

On the front surface of the mobile PC 16, five buttons 202 constituted of an up button 202a, a right button 202b, a down button 202c, a left button 202d, and a decision button 202e (also called a center button or an enter button) are arranged, and a fingerprint sensor 204 is arranged below the five buttons 202. The mobile PC 16 is not provided with a hardware input keyboard for inputting characters or numerals, and a password number (also called a PIN) cannot be input. Therefore, the fingerprint sensor 204 is used for user authentication at the time of sign-in of the mobile PC 16. The five buttons 202 can input a command.

User authentication at the time of sign-in may be carried out by allocating numeric values to the buttons 202a to 202d of the five buttons 202, and by inputting a password number using the five buttons 202. In this case, the fingerprint sensor 204 can be omitted. Numeric values are allocated to the four buttons 202a to 202d other than the decision button 202e, and the number of the numeric values is only four. Thus, there is a possibility of numeric values input in a random manner being coincident with the password number. However, by making the digit number of the password large, it is possible to make the probability that the numeric values input in a random manner will be coincident with the password number low. Authentication by the five buttons 202 may be enabled in also the mobile PC 16 provided with the fingerprint sensor 204. Although one mobile PC 16 may be shared among a plurality of users, it is not possible to cope with such a case by only the fingerprint authentication.

The operations identical to those of the buttons 102, 104, 106, and 108, and the touch pad 110 of the wearable device main body 24 can also be applied to the five buttons 202. The user cannot watch the state where the buttons 102, 104, 106, and 108, and the touch pad 110 of the wearable device main body 24 are being operated. Therefore, it may be necessary for a user to become accustomed to carrying out an intended operation depending on the user. Further, the buttons 102, 104, 106, and 108 and the touch pad 110 are small in size, and thus they may be difficult to operate. In the embodiment, the five buttons 202 of the mobile PC 16 can also be operated in the same manner as above, and hence the above-mentioned fear can be dispelled. The operation procedures of the five buttons 202 are determined by the application program.

For example,

when the decision button 202e is pressed once, item selection/item execution is carried out (corresponding to pressing once of the third button 106 in the wearable device main body 24),

when the decision button 202e is pressed for a long time, ending or cancellation of an operation is carried out (corresponding to pressing once of the first button 102 in the wearable device main body 24),

when the up button 202a is pressed once, the cursor is moved upward (corresponding to upward drag on the touch pad 110 in the wearable device main body 24),

when the up button 202a is pressed for a long time, a list of activated application programs is displayed (corresponding to pressing the third button 106 for a long time in the wearable device main body 24),

when the down button 202c is pressed once, the cursor is moved downward (corresponding to downward drag on the touch pad 110 in the wearable device main body 24),

when the down button 202c is pressed for a long time, a menu of quick settings is displayed (corresponding to pressing of the second button 104 for a long time in the wearable device main body 24),

when the left button 202d is pressed once, the right icon is selected (corresponding to backward drag/flick on the touch pad 110 in the wearable device main body 24), and

when the right button 202b is pressed once, the left icon is selected (corresponding to forward drag/flick on the touch pad 110 in the wearable device main body 24).

On the upper side face of the mobile PC 16, a USB 3.0 connector 206, a USB type-C connector 207, and an audio jack 208 are provided.

On one side face (side face on the left side when viewed from the front) of the mobile PC 16, a memory card slot 218 for a memory card is provided. The memory card includes, for example, an SD card (registered trade mark), a micro SD card (registered trade mark), and the like.

On the other side face (side face on the right side when viewed from the front) of the mobile PC 16, a slot 210 for Kensington Lock (registered trade mark), a power switch 212, a power LED 213, a DC IN/battery LED 214, a DC terminal 216, and ventilation holes 222 for cooling are provided. The power LED 213 is arranged around the power switch 212, and turned on during the period of power-on. The DC IN/battery LED 214 indicates the state of the mobile PC 16 such as whether or not a battery is being charged, and the remaining battery level. Although the mobile PC 16 can be driven by the battery, the mobile PC 16 can also be driven in the state where the AC adaptor (not shown) is connected to the DC terminal 216. Although not shown, the back side of the mobile PC 16 is configured such that the battery can be replaced with a new one by a one-touch operation.

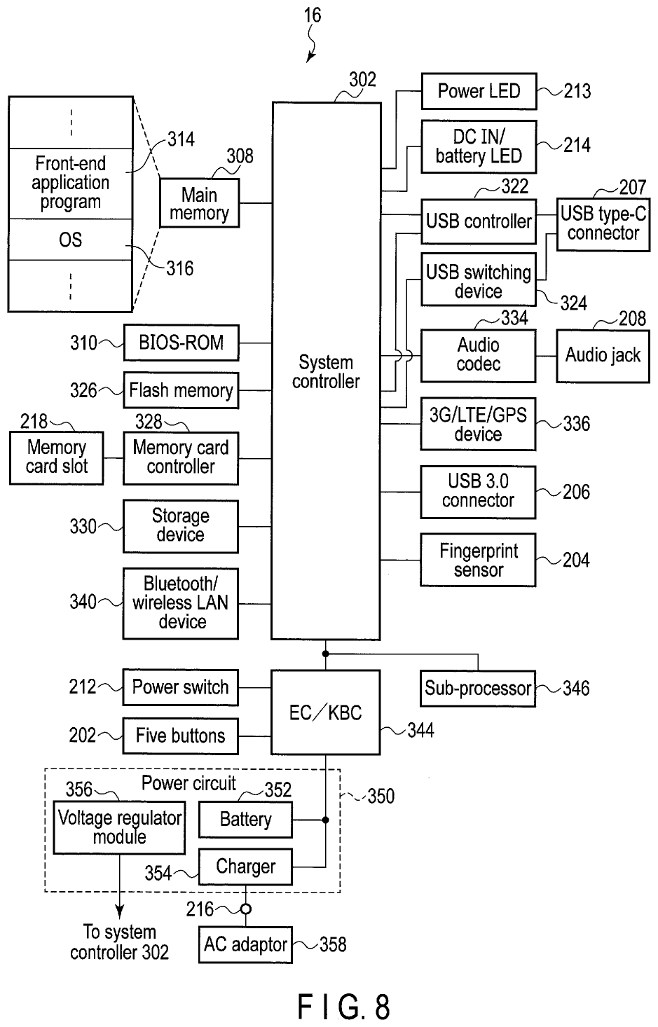

FIG. 8 is a block diagram showing an exemplary structure of the mobile PC 16. The mobile PC 16 can carry out video distribution of an image shot by the wearable device main body 24 to the operator terminal 12, and enables browse of the image received from the operator terminal 12. For this reason, the mobile PC 16 is provided with a camera function and a viewer function. The camera function is a function of shooting a photograph or a video by means of the camera 116 of the wearable device main body 24. The shot photograph and video are stored in a camera folder (not shown) in the mobile PC 16, and can be browsed by the viewer function. The viewer function is a function of enabling browse of a file stored in the camera folder. The types of the files include still images, moving images, PDF files, photographs and videos shot by the camera function, images received from the operator terminal 12, images transmitted to the operator terminal 12, and files stored in a user folder (not shown) in the mobile PC 16.

The mobile PC 16 is provided with a system controller 302. The system controller 302 is constituted of a processor (CPU) and a controller/hub (not shown in FIG. 8). A main memory 308, a BIOS-ROM 310, the power LED 213, the DC IN/battery LED 214, and a USB controller 322 are connected to the processor of the system controller 302. A flash memory 326, a memory card controller 328, a storage device 330 such as an HDD or an SSD, a USB switching device 324, an audio codec 334, a 3G/LTE/GPS device 336, the fingerprint sensor 204, the USB 3.0 connector 206, a Bluetooth/wireless LAN device 340, and an EC/KBC 344 are connected to the controller/hub of the system controller 302.

The system controller 302 executes various programs to be loaded from the storage device 330 into the main memory 308. These programs include an OS 316, and a front-end application program 314 for remote support. The front-end application program 314 includes a screen direction control program. The system controller 302 also executes the Basic Input/Output System (BIOS) stored in the BIOS-ROM 310 which is a nonvolatile memory. The BIOS is a system program for hardware control.

The audio codec 334 converts a digital audio signal which is an object (to be reproduced) into an analog audio signal, and supplies the converted analog audio signal to the audio jack 208. Further, the audio codec 334 converts an analog audio signal (input from the audio jack 208) into a digital signal.

The memory card controller 328 accesses to a memory card such as an SD card to be inserted into the memory card slot 218, and controls read/write of data from/to the SD card.

The USB controller 322 carries out control of transmission/reception of data to/from the USB type-C cable 146 (shown in FIG. 5) connected to the USB type-C connector 207 or the USB 3.0 cable (not shown) connected to the USB 3.0 connector 206.

Although not shown, a port extension adaptor including ports or connectors according to several interfaces can be connected also to the USB type-C connector 207, and an interface which is not provided in the mobile PC 16, such as the HDMI or the like, can be used.

The Bluetooth/wireless LAN device 340 executes wireless communication conforming to the Bluetooth/IEEE802.11 standard for the purpose of connection to the network 22. The connection to the network 22 may not depend on wireless communication, and may depend on wired LAN communication conforming to the IEEE802.3 standard.

The fingerprint sensor 204 is used for fingerprint authentication at the time of startup of the mobile PC 16.

A sub-processor 346, the power switch 212, and the five buttons 202 are connected to the EC/KBC 344. The EC/KBC 344 has a function of turning on or turning off the power to the mobile PC 16 according to the operation of the power switch 212. The control of power-on and power-off is executed by cooperative operation of the EC/KBC 344 and the power circuit 350. Even during a power-off period of the mobile PC 16, the EC/KBC 344 operates by the power from a battery 352 or an AC adaptor 358 (connected as an external power supply). The power circuit 350 uses the power from the battery 352 or the AC adaptor 358 to thereby generate power to be supplied to each component. The power circuit 350 includes a voltage regulator module 356. The voltage regulator module 356 is connected to the processor in the system controller 302.

Although the mobile PC 16 is constituted as a body separate from the wearable device main body 24, the mobile PC 16 may be incorporated into the wearable device main body 24, and both of them may also be integrated into one body.

[Five Buttons Operation Mode]

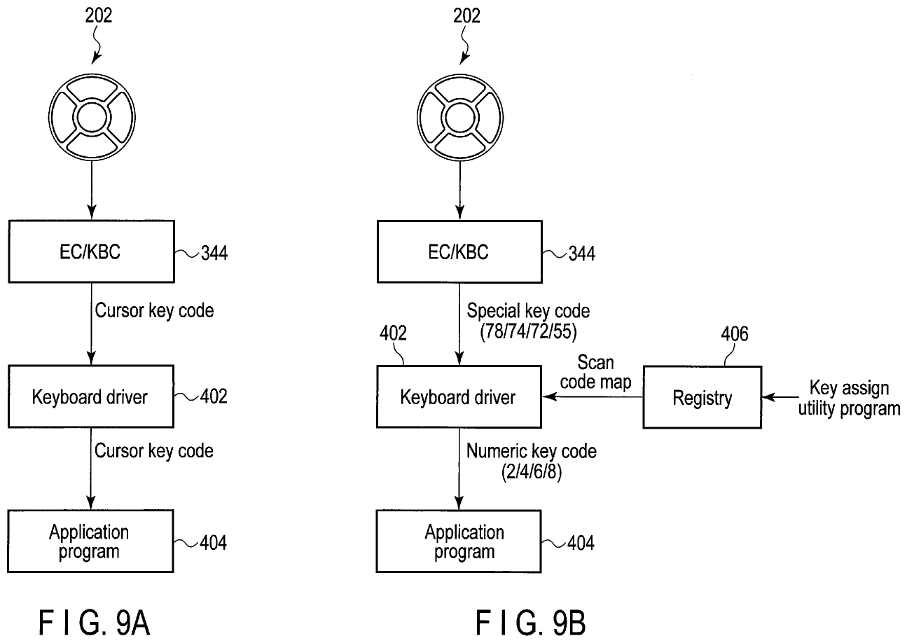

As described above, operation modes of the five buttons 202 can be switched in order to perform a user authentication at the time of sign-in by inputting a password number. The operation modes include a normal mode in which the five buttons 202 are operated as buttons for cursor movement (FIG. 9A) and a numeric key mode in which the five buttons 202 are operated as numeric keys (FIG. 9B). The modes of the five buttons 202 are switched depending on whether or not the EC/KBC 344 is set to a special key mode. The EC/KBC 344 can switch the special key mode between on/off states on the basis of a utility program or a command input by a user.

If the special key mode is turned off by the EC/KBC 344, the five buttons 202 are operated in the normal mode. In that case, when a key signal from the five buttons 202 is input into the EC/KBC 344, a cursor key code is output from the EC/KBC 344. The EC/KBC 344 converts signals from the up button 202a, the right button 202b, the down button 202c, and the left button 202d into cursor key codes to move the cursor upward, rightward, downward, and leftward, respectively and supplies the cursor key codes to a keyboard driver 402. In that case, the keyboard driver 402 supplies the cursor key codes to an application program 404 as they are. Thus, in the normal mode, a user can move the cursor in up, down, right, and left directions by operating the five buttons 202.

If the special key mode is turned on by the EC/KBC 344, the five buttons 202 are operated in the numeric key mode. In that case, when a key signal from the five buttons 202 is input into the EC/KBC 344, a special key code is output from the EC/KBC 344. The EC/KBC 344 converts signals from the up button 202a, the right button 202b, the down button 202c, and the left button 202d into special key codes indicative of certain numbers, for example, 78, 74, 72, and 55 and supplies the special key codes to the keyboard driver 402. In that case, the keyboard driver 402 converts the special key codes into numeric key codes on the basis of a scan code map stored in a registry 406 and supplies the numeric key codes to the application program 404.

A scan code map describes a definition to convert the special key codes into the numeric key codes. On the basis of the definition, the keyboard driver 402 converts the special key codes indicative of 78, 74, 72, and 55 into the numeric key codes indicative of 2, 4, 6, and 8, for example. The scan code map is set in the registry 406 by a key assign utility program. The key assign utility program is installed in the main memory 308 of the mobile PC 16. Thus, in the numeric key mode, a user can input numeric key code by operating the five buttons 202.

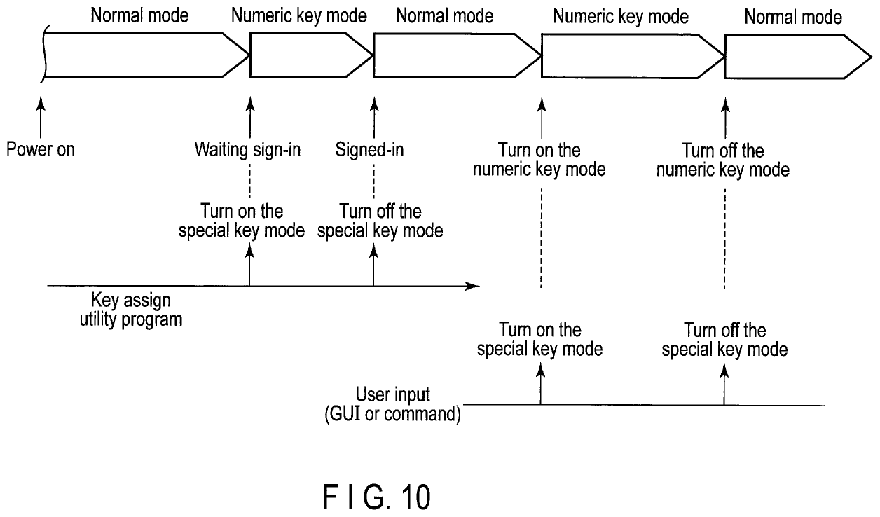

FIG. 10 shows switching of the five buttons 202 between the normal mode and the numeric key mode. When the mobile PC 16 is turned on, the key assign utility program is activated. In the activation, the key assign utility program turns off the special key mode of the EC/KBC 344. Thus, the operation mode of the five buttons 202 is set to the normal mode. Then, a boot program is executed, a sign-in authentication process is started for OS activation, and an authentication standby state is set. In the authentication standby state, the mobile PC 16 displays a password (PIN) input screen on the display device 124 of the wearable device main body 24 for the OS activation. The PIN input screen includes a message for users such as “Please input PIN of four digits and press enter”. The PIN is preliminarily set by a user and is stored in the storage device 330 of the mobile PC 16. Note that the PIN is not limited to four digits and may be a greater number such as ten digits. In the authentication standby state, the key assign utility program turns on the special key mode of the EC/KBC 344. Thus, the operation mode of the five buttons 202 is set to the numeric key mode. In this case, as shown in FIG. 9B, the numbers indicative of PIN are input by the five buttons 202.

When the PIN authentication succeeds, the key assign utility program turns off the special key mode of the EC/KBC 344. Thus, the operation mode of the five buttons 202 is set to the normal mode. Then, as shown in FIG. 9A, the movement of cursor and the like are instructed by the five buttons 202.

When a user selects mode switching or inputs a mode switching command on a screen (GUI) in the normal mode, the special key mode of the EC/KBC 344 is turned on. Thus, the operation mode of the five buttons 202 is switched to the numeric key mode at an optional time desired by a user. Similarly, in the numeric key mode, when a user selects mode switching or inputs a mode switching command on the screen (GUI), the special key mode of the EC/KBC 344 is turned off, and the operation mode of the five buttons 202 is switched to the normal mode at an optional time desired by a user.

[State Display]

While the mobile PC 16 without a display is connected to the wearable device main body 24, messages indicative of various states of the system are displayed on the display device 124 of the wearable device main body 24. A user can recognize a state of the system such as an error from the messages. However, if the wearable device main body 24 is not connected to the mobile PC 16, the user cannot recognize states of the system. States of the system include, for example, state of power/OS, battery charge state, internet connection state, and lock/unlock state of five buttons. According to the embodiment, the mobile PC 16 includes the power LED 213 and the DC IN/battery LED 214 on a side surface of the casing such that various states of the system can be notified to a user by changing a color and a behavior of the LEDs.

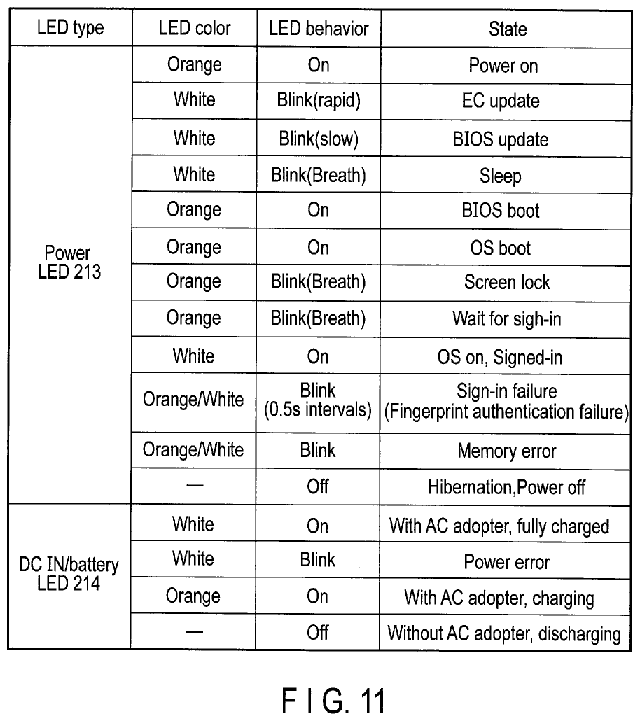

FIG. 11 shows an example of the color and the behavior of the power LED 213 and the DC IN/battery LED 214 of the mobile PC 16.

The LED color and the LED behavior of the power LED 213 is changed depending on the power state or the state of the OS.

When the power state of the system is an on state, the power LED 213 is lit in orange.

When the firmware of the EC/KBC 344 is updated, the power LED 213 blinks in white.

When the BIOS is updated, the power LED 213 blinks in white. The blink rate during the update of the BIOS is slower than the blink rate during the update of firmware of the EC/KBC 344.

When the power state of the system is a sleep state (S3 state), the power LED 213 blinks in white and is gradually lit (breath).

In the boot of the BIOS, the power LED 213 is lit in orange.

In the boot of the OS, the power LED 213 is lit in orange.

In a screen is locked, the power LED 213 blinks in orange and is gradually lit (breath).

In a waiting period for sign-in, the power LED 213 blinks in orange and is gradually lit (breath).

When the OS is on or the sign-in succeeds, the power LED 213 is lit in white.

When the sign-in fails, the power LED 213 blinks in orange and white at intervals of 0.5 s. The sign-in is performed through fingerprint authentication, and the sign-in fails if the fingerprint authentication fails for predetermined times. The predetermined times can be changed by setting and the default value is three, for example.

If there is a memory error, the power LED 213 blinks in orange and white.

When the power state of the system is in a hibernation state (S4 state) or the power is off (S5 state), the power LED 213 turns off.

Thus, even if the wearable device main body 24 is not connected to the mobile PC 16, a user can visually recognize states of the power and the system on the basis of the color and the lighting behavior of the power LED 213.

The DC IN/battery LED 214 changes the color and the lighting behavior thereof depending on a charge state.

When the AC adapter 358 is connected and the battery 352 is fully charged, the DC IN/battery LED 214 is lit in white.

If there is a power error, the DC IN/battery LED 214 blinks in white.

When the AC adapter 358 is connected and the battery 352 is being charged, the DC IN/battery LED 214 is lit in orange.

When the AC adapter 358 is not connected and the battery 352 is being discharged, the DC IN/battery LED 214 is turned off.

Thus, even if the wearable device main body 24 is not connected to the mobile PC 16, a user can visually recognize a charge state of the battery 352 on the basis of the color and the lighting behavior of the DC IN/battery LED 214.

Combinations of the color, the lighting behavior, and the state of FIG. 11 are merely an example, and combinations can be arbitrarily changed.

[Commands by Button Operation]

Since the mobile PC 16 does not include a hardware input keyboard for inputting characters or numerals, and thus, commands cannot be input. According to the embodiment, the mobile PC 16 includes the five buttons 202 and a command can be input by a combination of the five buttons 202. Furthermore, since the mobile PC 16 does not include a display, contents of the command and a state of execution of the command cannot be confirmed. According to the embodiment, the mobile PC 16 of the embodiment includes the power LED 213 and the DC IN/battery LED 214 such that the contents of the command and the state of execution of the command can be notified to a user by changing the color and the light behavior of the power LED 213 and the DC IN/battery LED 214.

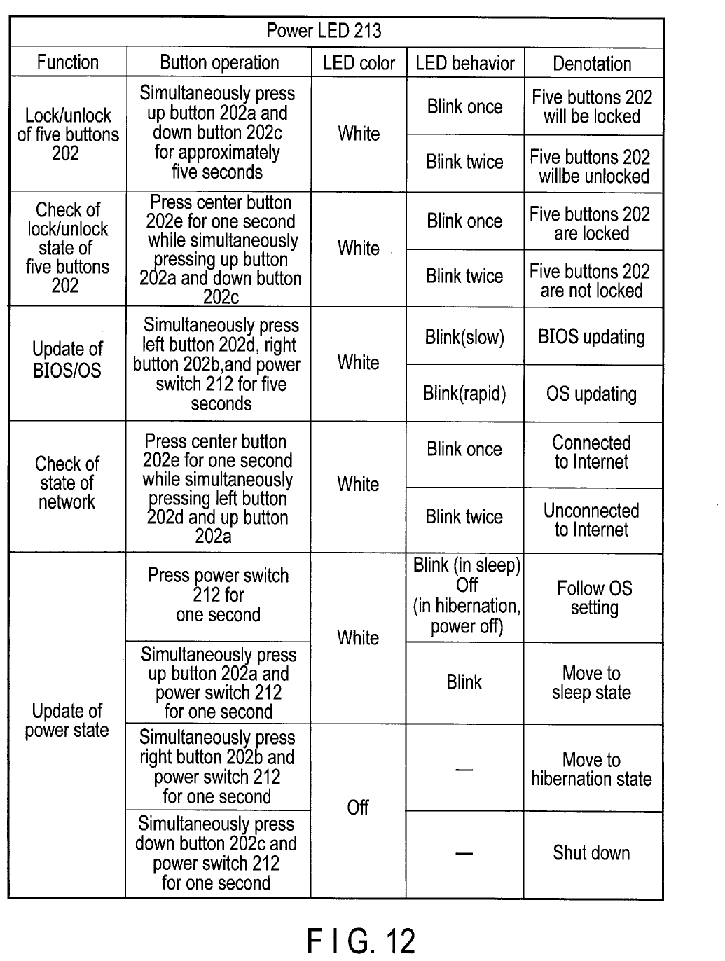

FIG. 12 shows an example of functions executed by the operation of the five buttons 202 and the color and the behavior of the power LED 213.

When the up button 202a and the down button 202c are simultaneously pressed for approximately five seconds, the five buttons 202 are locked or unlocked.

When the above operation is performed while the five buttons 202 are unlocked, the five buttons 202 are locked. At that time, the power LED 213 blinks once in white.

When the above operation is performed while the five buttons 202 are locked, the five buttons 202 are unlocked. At that time, the power LED 213 blinks twice in white.

When the center button 202e is pressed for approximately one second while simultaneously pressing the up button 202a and the down button 202c, the lock/unlock state of the five buttons 202 is checked. If the five buttons 202 are locked, the power LED 213 blinks once in white. If the five buttons 202 are unlocked, the power LED 213 blinks twice in white. The check of the lock/unlock state of the five buttons 202 can be performed even if the five buttons 202 are locked.

When the left button 202d, the right button 202b, and the power switch 212 are simultaneously pressed for approximately five seconds, the BIOS/OS can be updated. During the update of the BIOS, the power LED 213 blinks in white. During the update of the OS, the power LED 213 blinks in white. The blink rate during the update of the OS is faster than the blink rate during the update of the BIOS.

When the center button 202e is pressed for approximately one second while simultaneously pressing the left button 202d and the right button 202b, the network connection state is checked. If the mobile PC 16 is connected to the internet, the power LED 213 blinks once in white. If the mobile PC 16 is not connected to the internet, the power LED 213 blinks twice in white.

The mobile PC 16 can be in various power states and the power states can be changed by operating the power source switch 212 and the five buttons 202. In order to increase a battery drive time as long as possible, the mobile PC 16 is put in a hibernation state if there is no operation thereto for a certain period of time. Furthermore, when the wearable device main body 24 is detached from the mobile PC 16, the wearable device main body 24 is put in a sleep state and then, the mobile PC 16 is also put in a sleep state.

When the power source switch 202 is pressed for one second, the power state moves to one according to setting of OS. If the power state moves to a sleep state, the power LED 213 blinks, and if the power state moves to a hibernation state or a power off state, the power LED 213 is turned off.

When the up button 202a and the power source switch 202 are simultaneously pressed for one second, the power state moves to a sleep state. At that time, the power LED 213 blinks.

When the right button 202b and the power source switch 202 are simultaneously pressed for one second, the power state moves to a hibernation state. At that time, the power LED 213 is turned off.

When the down button 202c and the power source switch 202 are simultaneously pressed for one second, the power state moves to a shut down state. At that time, the power LED 213 is turned off.

Thus, even if the wearable device main body 24 and a hardware input keyboard for inputting characters or numerals are not connected to the mobile PC 16, a user can input a command by operating the five buttons 202 in combination and can visually recognize the state of execution of the command on the basis of the color and the lighting behavior of the power LED 213.

Combinations of the functions, the button operations, the LED colors, the LED behaviors, and the denotations of FIG. 12 are merely an example, and combinations can be arbitrarily changed.

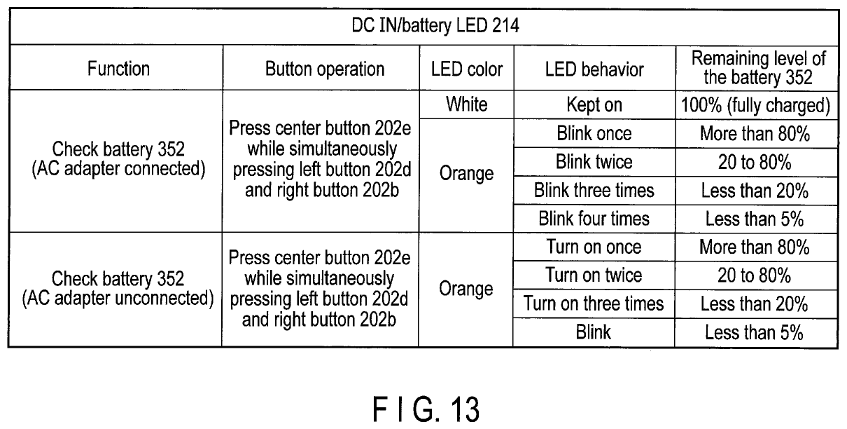

FIG. 13 shows an example of a battery check function of the mobile PC 16 executed by the operation of the five buttons 202 and the color and the lighting behavior of the DC IN/battery LED 214. In the mobile PC 16 according to the embodiment, when the center button 202e is pressed while simultaneously pressing the left button 202d and the right button 202b, the battery check is performed. The battery check can be performed even while the five buttons 202 are locked.

When the remaining level of the battery 352 is 100% (fully charged) while the AC adapter 358 is connected, the DC IN/battery LED 214 is lit in white. The lighting behavior is not changed by the button operation.

When the remaining level of the battery 352 is more than 80% while the AC adapter 358 is connected, the DC IN/battery LED 214 blinks once in orange (i.e., orange, off, orange). When the remaining level of the battery 352 is 20 to 80% while the AC adapter 358 is connected, the DC IN/battery LED 214 blinks twice in orange (i.e., orange, off, orange, off, orange). When the remaining level of the battery 352 is less than 20% while the AC adapter 358 is connected, the DC IN/battery LED 214 blinks three times in orange (i.e., orange, off, orange, off, orange, off, orange). When the remaining level of the battery 352 is less than 5% while the AC adapter 358 is connected, the DC IN/battery LED 214 blinks four times in orange (i.e., orange, off, orange, off, orange, off, orange, off, orange).

When the remaining level of the battery 352 is more than 80% while the AC adapter 358 is not connected, the DC IN/battery LED 214 is lit once in orange (i.e., off, orange, off). When the remaining level of the battery 352 is 20 to 80% while the AC adapter 358 is not connected, the DC IN/battery LED 214 is lit twice in orange (i.e., off, orange, off, orange, off). When the remaining level of the battery 352 is less than 20% while the AC adapter 358 is not connected, the DC IN/battery LED 214 is lit three times in orange (i.e., off, orange, off, orange, off, orange, off).

When the remaining level of the battery 352 is less than 5% while the AC adapter 358 is not connected, the DC IN/battery LED 214 blinks in orange. The blinking state is not changed by the button operation.

Thus, even if the wearable device main body 24 and the hardware input keyboard for inputting characters or numerals are not connected to the mobile PC 16, a user can instruct a battery check to the mobile PC 16 by operating a combination of the five buttons 202 and can visually recognize the remaining level of the battery on the basis of color and the lighting behavior of the DC IN/battery LED 214.

Combinations of the functions, the button operations, the LED colors, the LED behaviors, and the remaining levels of the battery of FIG. 13 are merely an example, and combinations can be arbitrarily changed.

[Example of Arrangement of the Power LED 213 and the DC IN/Battery LED 214]

As shown in FIG. 7, the power LED 213 and the DC IN/battery LED 214 are provided with the side surface of the mobile PC 16. When the states of the system are indicated as shown in FIG. 11, there is no need of operating the five buttons 202, and thus, the LEDs 213 and 214 provided with the side surface of the mobile PC 16 can notify the state of the system to a user. However, when the state of command execution is to be checked by operating the five buttons 202 to input commands as shown in FIGS. 12 and 13, the button operation may be made by placing the bottom surface of the mobile PC 16 on a flat surface such as a desk. In that case, the user sees the front surface of the mobile PC 16, and thus, the color and the behavior of the LEDs 213 and 214 provided with the side surface may be difficult to visually recognize.

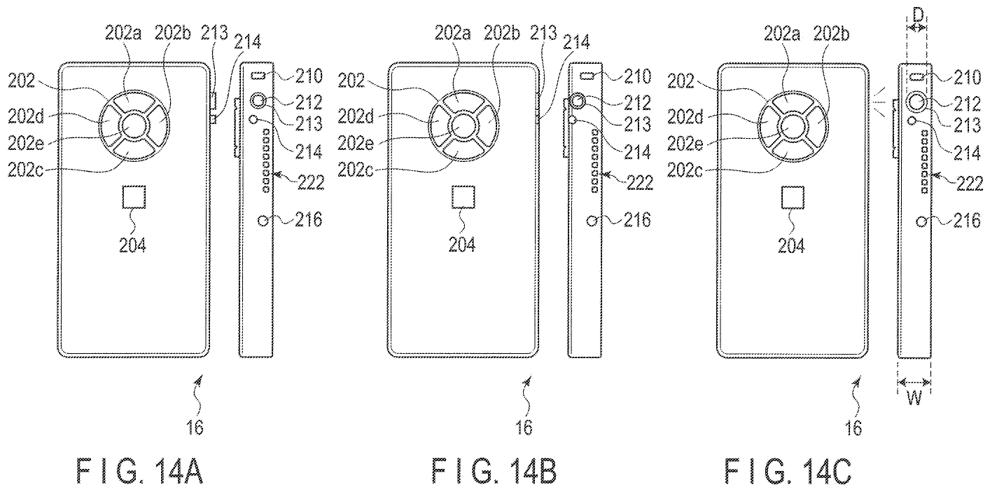

By changing the arrangement of the power LED 213 and the DC IN/battery LED 214 as shown in FIGS. 14A, 14B, and 14C, the user can check the color and the behavior of the LEDs 213 and 214 with good visibility even if the mobile PC 16 is seen from the front.

In a variation of FIG. 14A, the power LED 213 and the DC IN/battery 214 are formed as protrusions protruding from the side surface of the mobile PC 16, and the peripheral surface of the protrusion is formed as a luminous surface.

In a variation of FIG. 14B, the power LED 213 and the DC IN/battery LED 214 are provided with the side surface of the mobile PC 16 and are partly provided with the front surface of the mobile PC 16.

That is, the power LED 213 and the DC IN/battery LED 214 are provided with both the front surface and the side surface and are partly exposed in the front surface.

In a variation of FIG. 14C, the power LED 213 and the DC IN/battery LED 214 are realized as LEDs of high brightness. To increase the brightness of an LED, a diameter thereof is increased, for example. In this example, the diameter of the power LED 213 is increased, for example. If the power LED 213 has a diameter D which is equal to or greater than a half the width W of the side surface of the mobile PC 16, the user can check the color and the behavior of the LEDs 213 and 214 provided with the side surface of the mobile PC 16 with good visibility even if the mobile PC 16 is seen from the front.

With the above variations, the color and the behavior of the power LED 213 and the DC IN/battery LED 214 can be recognized even if the mobile PC 16 is seen from the front.

Since the processes of the present embodiment can be realized by computer program, the advantages of the present embodiment can easily be achieved by installing the computer program in a computer via a computer-readable storage medium storing the computer program.

According to embodiments, following electronic edge computing devices and systems are provided.

An electronic edge computing device without a display and without a hardware input keyboard, the electronic edge computing device comprising:

a light source that emits light of at least two colors, wherein a light emission mode of the light source comprises an on mode, a blink mode, and an off mode; and a controller that controls a color of the light emitted from the light source and the light emission mode of the light source based at least in part on a state of the electronic edge computing device.

The electronic edge computing device of (1), wherein

the light source comprises a light emitting diode that emits light of at least two colors, wherein a light emission mode of the light emitting diode comprises the on mode, the blink mode, and the off mode; and

the controller controls the color of the light emitted from the light emitting diode and the light emission mode of the light emitting diode based at least in part on the state of the electronic edge computing device.

The electronic edge computing device of (1), wherein

the electronic edge computing device comprises a battery-powered device;

the light source comprises a first light emitting diode that emits light of at least two colors and a second light emitting diode that emits light of at least two colors, wherein a light emission mode of the first light emitting diode comprises the on mode, the blink mode, and the off mode; and

the controller controls the color of the light emitted from the second light emitting diode and the light emission mode of the first light emitting diode based at least in part on a charging state of the battery.

The electronic edge computing device of (1), further comprising:

an embedded controller with a firmware, wherein

the light source comprises a light emitting diode that emits light of at least two colors, wherein a light emission mode of the light emitting diode comprises the on mode, the blink mode, and the off mode; and

the controller controls the color of the light emitted from the light emitting diode and the light emission mode of the light emitting diode based at least in part on a state of the firmware of the embedded controller.

The electronic edge computing device of (1), wherein

the light source comprises a light emitting diode that emits light of at least two colors, wherein a light emission mode of the light emitting diode comprises the on mode, the blink mode, and the off mode; and

the controller controls the color of the light emitted from the light emitting diode and the light emission mode of the light emitting diode based at least in part on a state of a basic input/output system of the electronic edge computing device.

The electronic edge computing device of (2), wherein

the light source comprises a light emitting diode that emits light of at least two colors, wherein a light emission mode of the light emitting diode comprises the on mode, the blink mode, and the off mode; and

the controller controls the color of the light emitted from the light emitting diode and the light emission mode of the light emitting diode based at least in part on a state of an operating system of the electronic edge computing device.

The electronic edge computing device of (1), wherein

the light source comprises a light emitting diode that emits light of at least two colors, wherein a light emission mode of the light emitting diode comprises the on mode, the blink mode, and the off mode; and

the controller controls the color of the light emitted from the light emitting diode and the light emission mode of the light emitting diode based at least in part on a state of sign-in of the electronic edge computing device.

The electronic edge computing device of (1), wherein

the light source comprises a light emitting diode that emits light of at least two colors, wherein a light emission mode of the light emitting diode comprises the on mode, the blink mode, and the off mode;

the electronic edge computing device further comprises operation buttons, and

when at least one of the operation buttons is operated, the controller controls the color of the light emitted from the light emitting diode and the light emission mode of the light emitting diode based at least in part on an operation of the at least one of the operation buttons and a manner of the operation of the at least one of the operation buttons.

The electronic edge computing device of (8), wherein

the operation buttons are locked when a first operation button of the operation buttons is operated;

the operation buttons are unlocked when a second operation button of the operation buttons is operated; and

the controller controls a number of blinks of the light emitting diode in the blink mode when the operation buttons are locked or when the operation buttons are unlocked.

The electronic edge computing device of (9), wherein

when the at least one of the operation buttons is operated, the controller controls the number of blinks of the light emitting diode in the blink mode based at least in part on a locked state or an unlocked state of the operation buttons.

The electronic edge computing device of (8), wherein

when the at least one of the operation buttons is operated, the controller controls a blink rate of the light emitting diode in the blink mode based at least in part on an update state of a basic input/output system or an operating system of the electronic edge computing device.

The electronic edge computing device of (8), wherein

the electronic edge computing device connects to an internet connection; and

when the at least one of the operation buttons is operated, the controller controls the color of the light emitted from the light emitting diode and the light emission mode of the light emitting diode based at least in part on a connection state of the electronic edge computing device with the internet connection.

The electronic edge computing device of (8), wherein

when the at least one of the operation buttons is operated, a power state of the electronic edge computing device is set to a power off state, a sleep state, a hibernation state, or a power on state,

the controller controls the color of the light emitted from the light emitting diode and the light emission mode of the light emitting diode based at least in part on the power state of the electronic edge computing device.

The electronic edge computing device of (8), wherein

the electronic edge computing device comprises a battery-powered device; and

when the at least one of the operation buttons is operated, the controller controls the color of the light emitted from the light emitting diode and the light emission mode of the light emitting diode based at least in part on a remaining power of the battery.

The electronic edge computing device of (14), wherein

when the at least one of the operation buttons is operated, the controller controls a number of blinks of the light emitting diode in the blink mode based at least in part on the remaining power of the battery and a connection state of the battery to the electronic edge computing device.

The electronic edge computing device of (8), wherein

the electronic edge computing device comprises a casing comprising a flat rectangular parallelepiped shape;

the operation buttons are provided at a front surface of the casing; and

the light emitting diode is provided at a side surface of the casing, the light emitting diode protruding from the side surface of the casing.

The electronic edge computing device of (8), wherein

the electronic edge computing device comprises a casing comprising a flat rectangular parallelepiped shape;

the operation buttons are provided at a front surface of the casing; and

the light emitting diode is provided in a side surface of the casing and the front surface of the casing, a part of the light emitting diode exposed in the front surface.

The electronic edge computing device of (17), wherein

a diameter of the light emitting diode is equal to or greater than a half of a thickness measured from a top surface to a bottom surface of the casing.

A system comprising:

a wearable device comprising a display; and

an electronic edge computing device that is electrically connected to the wearable device and supplies an image signal to the display, wherein

the wearable device comprises first operation buttons that generates first key signals;

the electronic edge computing device comprises second operation buttons that generates second key signals wherein a number of the second operation buttons is greater than a number of the first operation buttons; and

the electronic edge computing device assigns a same operation to one of the first key signals and one of the second key signals.

The system of (19), wherein

the wearable device comprises a glasses-type wearable device;

the first operation buttons are provided in the side surface of the glasses-type wearable device;

the first operation buttons generate a key signal for selection and execution of an item and a key signal for cancellation of operation;

the second operation buttons are provided in a front surface of a flat rectangular parallelepiped casing of the electronic edge computing device; and

the second operation buttons generate a key signal for selection and execution of an item and a key signal for cancellation of operation.

A system of (20), wherein

the wearable device comprises a touchpad provided in the side surface of the glasses-type wearable device; and

the touchpad generates a key signal for moving a cursor upward corresponding to upward dragging, a key signal for moving the cursor downward corresponding to downward dragging, a key signal for successively selecting left icons corresponding to frontward flicking, a key signal for successively selecting right icons corresponding to backward flicking, a key signal for selecting a left icon corresponding to frontward dragging, and a key signal for selecting a right icon corresponding to backward dragging, and the second operation buttons comprise an up button, a down button, a left button, a right button, and a center button, wherein

the center button generates a key signal for cancellation of operation,

the up button generates a key signal for upward movement of cursor,

the down button generates a key signal for downward movement of cursor,

the right button generates a key signal for selection of right icon, and the left button generates a key signal for selection of left icon.

A system comprising:

a wearable device comprising a camera, a display device, a touchpad, and first operation buttons; and

an electronic edge computing device that is wirelessly connected to an external device, is electrically connected to the wearable device through a cable, comprises second operation buttons, and supplies a power voltage and image data to the wearable device, wherein

the electronic edge computing device comprises: a communication unit that communicates with the external device;

a transmitter that transmits image data captured by the camera to the external device;

a storage that stores the image data captured by the camera and image data transmitted from the external device;

a display controller that displays an operation menu and the image data transmitted from the external device or the image data read from the storage on the display device, and

a processor that selects an item in the operation menu corresponding to an operation of the first operation buttons, the touch pad, or the second operation buttons and executes a process corresponding to a selected item in the operation menu while the operation menu is displayed on the display device.

The system of (22), wherein

the electronic edge computing device comprises a battery charged with a voltage of a commercial power supply;

the electronic edge computing device is operable by the voltage of the commercial power supply or a voltage of the battery; and

the wearable device is inoperable when being unconnected with the electronic edge computing device.

The system of (22), wherein

the image data transmitted from the external device comprises instruction to a user of the wearable device.

The system of (22), wherein

the processor authenticates a user based on a fingerprint of the user or a combination of operations of the second operation buttons and the fingerprint of the user.

The system of (22), wherein

the wearable device is mounted on a head of a user; and

the electronic edge computing device comprises a portable device.

A system comprising:

a wearable device comprising a camera and a display; and

an electronic edge computing device that supplies a power supply voltage and image data to the wearable device via a cable, wherein

the wearable device comprises a casing having a partly curved surface and a receptacle at the partly curved surface wherein a plug of the cable is able to be inserted into the receptacle; and

a terminal of the receptacle is provided in a protrusion which protrudes from part of the casing.

The processing of this embodiment can be realized by means of a computer program, and hence it is possible to easily realize an advantage identical to this embodiment by only installing this computer program into a computer through a computer-readable storage medium storing therein this computer program, and executing this computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic edge computing device connected to a wearable device through a cable or a wireless system, wherein an audio communication is performed between the electronic edge computing device and the wearable device and a real time image is transmitted from the wearable device to the electronic edge device, and wherein the wearable device comprises first operation buttons and a touch pad, and first operation procedures of the first operation buttons and the touch pad are determined by an application program, the electronic edge computing device comprising:
second operation buttons, and second operation procedures of the second operation buttons being determined by the application program,
wherein functions executed by the first operation procedures caused by at least one of the first operation buttons and the touch pad of the wearable device are identical to functions executed by the second operation procedures by at least one of the second operation buttons.

2. The electronic edge computing device of claim 1, further comprising:
a power light emitting diode that emits light of at least two colors; and
a controller circuitry that controls the power light emitting diode, wherein
the controller circuitry changes a color of the light emitted from the power light emitting diode and switches a light emission mode of the power light emitting diode between a continuous mode and a blink mode based at least in part on an operating state of the electronic edge computing device after the electronic edge computing device is powered on, and
the first operation procedures caused by the first operation buttons, the colors of the light emitted from the power light emitting diode, and the light emission mode of the power light emitting diode are determined.

3. The electronic edge computing device according to claim 2, further comprising:
a battery charge light emitting diode that emits light of at least two colors; and
a battery, wherein
the controller circuitry changes a color of the light emitted from the battery charge light emitting diode and switches a light emission mode of the battery charge light emitting diode between a continuous mode and a blink mode based at least in part on a charging state of the battery when the battery is connected to an AC adaptor.

4. The electronic edge computing device according to claim 3, wherein:
when the at least two of the second operation buttons are simultaneously operated, the controller circuitry changes the color of the light emitted from the battery charge light emitting diode and switches the light emission mode of the battery charge light emitting diode between the continuous mode and the blink mode based at least in part on a remaining power of the battery.

5. The electronic edge computing device according to claim 3, wherein when the at least three of the second operation buttons are simultaneously operated, the controller circuitry controls a number of blinks or a number of emissions of the battery charge light emitting diode based at least in part on the remaining power of the battery and a connection state of the AC adaptor to the battery.

6. The electronic edge computing device according to claim 3, wherein:
the electronic edge computing device comprises a casing comprising a flat rectangular parallelepiped shape and operation buttons;
the second operation buttons are provided at a front surface of the casing; and
the power light emitting diode and the battery charge light emitting diode are provided at a side surface of the casing, the light power light emitting diode and the battery charge light emitting diode protruding from the side surface of the casing.

7. The electronic edge computing device according to claim 3, wherein:
the electronic edge computing device comprises a casing comprising a flat rectangular parallelepiped shape and the second operation buttons;
the second operation buttons are provided at a front surface of the casing; and
the power light emitting diode and the battery charge light emitting diode are provided in a side surface of the casing and the front surface of the casing, a part of the power light emitting diode and the battery charge light emitting diode exposed in the front surface.

8. The electronic edge computing device according to claim 7, wherein a diameter of the power light emitting diode is equal to or greater than a half of a thickness measured from a top surface to a bottom surface of the casing.

9. The electronic edge computing device according to claim 2, further includes an embedded controller with a firmware, and wherein:
the controller circuitry changes the color of the light emitted from the power light emitting diode and switches the light emission mode of the power light emitting diode between the continuous mode and the blink mode based at least in part on a state of the firmware of the embedded controller.

10. The electronic edge computing device according to claim 2, wherein the controller circuitry changes the color of the light emitted from the power light emitting diode and switches the light emission mode of the power light emitting diode between the continuous mode and the blink mode based at least in part on a state of a basic input/output system of the electronic edge computing device.

11. The electronic edge computing device according to claim 2, wherein:
the controller circuitry changes the color of the light emitted from the power light emitting diode and switches the light emission mode of the power light emitting diode between the continuous mode and the blink mode based at least in part on a state of an operating system of the electronic edge computing device.

12. The electronic edge computing device according to claim 2, wherein:
the controller circuitry changes the color of the light emitted from the power light emitting diode and switches the light emission mode of the power light emitting diode between the continuous mode and the blink mode based at least in part on a state of sign-in of the electronic edge computing device.

13. The electronic edge computing device according to claim 2, wherein:
when at least one of the second operation buttons is operated, the controller circuitry changes the color of the light emitted from the power light emitting diode and switches the light emission mode of the power light emitting diode between the continuous mode and the blink mode based on the second operation procedures comprising at least an operation of the at least one of the second operation buttons and a manner of the operation of the at least one of the second operation buttons.

14. The electronic edge computing device according to claim 13, wherein:
the electronic edge computing device further comprises a lock controller for locking or unlocking the second operation buttons when at least two of the second operation buttons are simultaneously operated;
the controller circuitry makes the power light emitting diode blink by a first number of blinks when the second operation buttons are locked by the lock controller, and makes the power light emitting diode blink by a second number of blinks when the second operation buttons are unlocked by the lock controller.

15. The electronic edge computing device according to claim 14, wherein:
when the at least three of the second operation buttons are simultaneously operated for checking a locked state or an unlocked state of the second operation buttons, the controller circuitry makes the power emitting diode blink by the first number of blinks when the locked state of the second operation buttons is checked and makes the power emitting diode blink by the second number of blinks when the unlocked state of the second operation buttons is checked.

16. The electronic edge computing device according to claim 13, wherein:
when the at least three of the second operation buttons are simultaneously operated, the controller circuitry controls a blink rate of the power light emitting diode in the blink mode based at least in part on an update state of a basic input/output system or an operating system of the electronic edge computing device.

17. The electronic edge computing device according to claim 13, wherein:
the electronic edge computing device is connectable to an internet connection; and
when the at least three of the second operation buttons are simultaneously operated, the controller circuitry changes the color of the light emitted from the power light emitting diode and switches the light emission mode of the power light emitting diode between the continuous mode and the blink mode based at least in part on a connection state of the electronic edge computing device with the internet connection.

18. The electronic edge computing device according to claim 13, wherein:
when the at least two of the second operation buttons are simultaneously operated, the controller circuitry changes the electronic edge computing device to a power off state, a sleep state, or a hibernation state; and
the controller circuitry changes the color of the light emitted from the power light emitting diode and switches the light emission mode of the power light emitting diode between the continuous mode and the blink mode based at least in part on a state of the electronic edge computing device.

19. The electronic edge computing device according to claim 1, further comprising a memory configured to store the application program.
